(19) United States
(12) Patent Application Publication
(10) Pub. No.: US 2016/0294428 A1
(43) Pub. Date: Oct. 6, 2016

(54) REGISTERING DISPLAY SCREEN PROTECTIVE FILMS

(71) Applicant: xLife INC, St. Louis Park, MN (US)

(72) Inventor: Zhong Ming Li, St. Louis Park, MN (US)

(21) Appl. No.: 14/672,404

(22) Filed: Mar. 30, 2015

(51) Int. Cl. H04B 1/3888; B29C 63/00

(52) U.S. Cl. CPC H04B 1/3888; B29C 63/0004; B29C 2063/0008; B29L 2031/3475

(57) ABSTRACT

Apparatus and associated methods relate to a mobile electronic device (MED) protective-film registration device having lateral and longitudinal engagement surfaces and lateral and longitudinal film-registration surfaces, the engagement surfaces configured to engage lateral and longitudinal sides of a MED, and when engaged, each film-registration surface substantially orthogonal to a target planar surface of the MED is substantially congruent to an edge portion of a protective-film when aligned and affixed to the display screen. In accordance with an exemplary embodiment, the longitudinal surface may prevent relative movement of the MED with respect to the engaged registration device in a direction perpendicular to the display screen. In various embodiments, a protective film may be guided to an aligned and affixed location on a display screen of a MED, by aligning the protective film to the MED-aligned film-registration device.

### TECHNICAL FIELD

Various embodiments relate generally to display-screen protection devices, and more specifically to aligning a protective-film to a display screen.

### BACKGROUND

Mobile electronic devices can be used for a variety of purposes. For example, a mobile electronic device may be used to communicate to a person at a different location (e.g., mobile phone). The same mobile electronic device may be used to access email and/or the internet. In another example, a mobile electronic device may be used to remotely control a network or a mechanical instrument.

As technology developed, the display screens on mobile electronic devices became more sophisticated. For example, a mobile electronic device for managing a music collection now uses an interactive touch-sensitive screen where its predecessor used mechanical buttons. Many mobile electronic devices now rely on graphical user interfaces for user input/output.

With technological advancement, mobile electronic devices reduced in size allowing for easier transportability. Easier transportability introduces an addition risk to the integrity of the mobile electronic device. Consumers place mobile electronic devices in purses, pant pockets, gym bags, and such. Many times the mobile electronic device shares the space with keys, pocket knives, and a number of other items. When transported in such a manner, the mobile electronic device risks its integrity as the any item can scratch, dent, or crack the mobile electronic device, in particular, the touch-sensitive screen.

### SUMMARY

Apparatus and associated methods relate to an apparatus for registering a protective film to a mobile electronic device (MED), the apparatus having lateral and longitudinal engagement surfaces and lateral and longitudinal film-registration surfaces, the engagement surfaces configured to engage lateral and longitudinal sides of a MED, and when engaged, each film-registration surface is coplanar with a plane having a display-screen intersection that is substantially congruent to an edge portion of a protective-film when aligned and affixed to the display screen. In accordance with an exemplary embodiment, the longitudinal surface may prevent relative movement of the MED with respect to the engaged registration device in a direction perpendicular to the display screen. In various embodiments, a protective film may advantageously be aligned to a MED by the concurrent alignment of the apparatus to both the protective film and the MED.

Various embodiments may achieve one or more advantages. For example, some embodiments may substantially increase the precision of registering a protective-film to a target planar surface of a MED. In some embodiments, the need for an apparatus with multiple separate components to properly register a protective-film may be substantially eliminated. For example, when a user is registering the protective-film, the user may not need an additional flange or alignment lugs to properly register the film. Some embodiments may decrease the likelihood of contaminants (e.g., dust) between the protective-film and the planar target surface of a MED. For example, some embodiments may increase the seal integrity between the protective-film and the planar target surface of a MED. Some embodiments may allow for registration on a smaller MED (e.g., iPhone® 6) and a larger MED (e.g., iPad® Air). In some embodiments, precision of the registration of the protective-film may be increased.

For example, some embodiments may secure the protective-film by limiting lateral, longitudinal, and/or rotational offsets between a protective-film and target planar surface of a MED during registration of the protective. In some embodiments, the speed of registering the protective film to the planar target surface may be increased. For example, a user may more quickly register the protective film to the MED without the need to use a flange. This is advantageous as the increase of speed may minimize user frustration. Further, minimizing user frustration may increase satisfaction. Some embodiments may induce sales of protective films, for example, with the increase ease of registering the protective film, a user may be more inclined to purchase a protective-film. In some embodiments, the user may extend the service life of the protective film. For example, when the protective film is properly registered, contaminants (e.g., dust) may be avoided.

Apparatus and associated methods may relate to a peripheral protective housing system for mobile electronic devices in which the system provides for removable attachment of a supplementary battery pack that can be attached or detached without disassembly or compromise of the peripheral protective housing. In an illustrative embodiment, the removable supplemental battery pack may slideably engage the peripheral protective housing on a rear side of the mobile electronic device. In some embodiments, battery connectors on both the removable supplemental battery and the peripheral protective housing may align when the removable supplemental battery is fully engaged to the peripheral protective housing. Various embodiments, may provide continuous peripheral protection of a mobile electronic device while a supplemental battery pack is replaced.

The details of various embodiments are set forth in the accompanying drawings and the description below. Other features and advantages will be apparent from the description and drawings, and from the claims.

### BRIEF DESCRIPTION OF THE DRAWINGS

FIGS. 1A-1E depict a side view of an exemplary film-registration device shown in a sequence of steps to register a protective-film to a mobile electronic device.

FIG. 2A depicts a top view of an exemplary film-registration device.

FIG. 2B depicts a rear view of an exemplary film-registration device.

FIG. 2C depicts a perspective view of an exemplary film-registration device.

FIG. 3 depicts a perspective view of an exemplary film-registration device engaged with a mobile electronic device.

FIG. 4 depicts a top view of an exemplary protective-film not properly registered to a mobile electronic device.

FIG. 5 depicts a perspective view of an exemplary film-registration device with a base member.

FIG. 6 depicts a perspective view of an exemplary pair of film-registration devices, each engaged to opposing sides of the mobile electronic device.

FIG. 7 depicts a top view of an exemplary film-registration device with lateral rails to engage a mobile electronic device along the minor axis of the mobile electronic device.

FIG. 8 depicts a perspective view of an exemplary kit including a protective-film with a U-shaped cutout and a film-registration device with a U-shaped protrusion.

FIG. 9 depicts a top view of an exemplary kit including a protective-film with a circle-shaped cutout and a film-registration device with a circle-shaped aperture.

FIG. 10A depicts a front view of an exemplary film-registration device with a U-shaped protrusion.

FIG. 10B depicts a front view of an exemplary film-registration device with a circle-shaped aperture.

FIG. 11 depicts a perspective view of an exemplary protection system for mobile electronic device.

FIG. 12 depicts an exemplary peripheral protection system separated from a mobile electronic device.

FIG. 13 depicts various plan and side-elevation views of an exemplary protective cover of a mobile electronic device with no supplementary batter pack attached.

FIG. 14 depicts various plan and side-elevation views of an exemplary protective cover of a mobile electronic device with a supplementary batter pack attached.

FIG. 15 depicts various plan and side-elevation views of an exemplary supplementary batter pack configured for attachment to a protection system for a mobile electronic device.

FIGS. 16A-16B depict side-elevation views of exemplary slideably connected battery packs.

FIG. 17 depicts a perspective view of an exemplary hingeably connected supplementary battery pack for a protected mobile electronics device.

FIG. 18 depicts a side elevation view of a cross-sectioned MED 800 in a contact event with a flat surface 810.

Like reference symbols in the various drawings indicate like elements.

### DETAILED DESCRIPTION OF ILLUSTRATIVE EMBODIMENTS

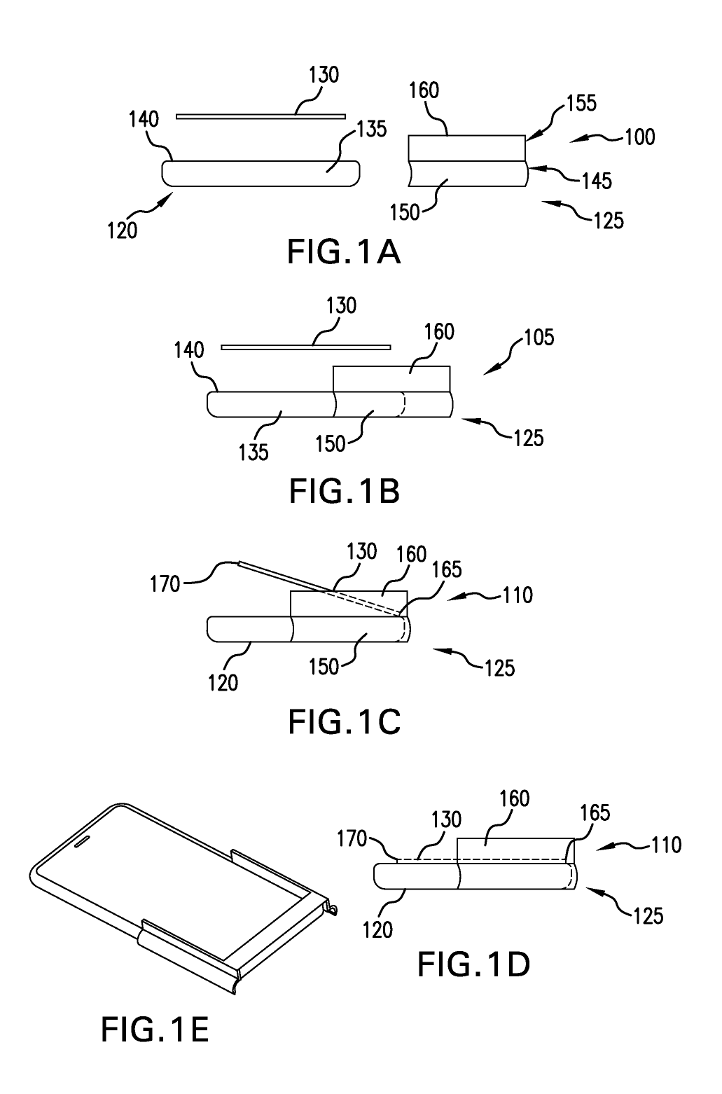

FIG. 1 depicts a side view of an exemplary film-registration device shown in a sequence of steps to register a protective-film to a mobile electronic device. As depicted, a sequence of five steps 1A, 1B, 1C, 1D, and 1E are shown. In FIG. 1A, a MED 120, a film-registration device 125, and a protective-film 130 are depicted unconnected to each other. The MED 120 includes opposing lateral sides 135. A planar target surface (e.g., a display screen) 140 extends between the lateral sides 135.

The film-registration device 125 includes a MED engagement portion 145. As depicted, the MED engagement portion 145 includes a pair of opposing lateral alignment members 150. In the depicted, the lateral alignment members 150 are rails to engage the opposing lateral sides 135 of the MED. The film-registration device 125 includes a film-registration portion 155. As depicted, the film-registration portion 155 includes lateral walls 160 extending from each of the lateral rails 150.

In FIG. 1B, the lateral sides 135 partially engage with the lateral rails 150. When engaged, the lateral walls 160 are coplanar with a plane having a display screen 140. Further, when engaged, the lateral alignment members 150 may restrict lateral movement of the MED with respect to the film-registration device 125. In FIG. 1C, the lateral walls 160 align to the display screen 140. As depicted, a right end 165 of the protective-film 130 is placed between the lateral walls 160 aligning the protective-film 130 to the display screen 140. In FIG. 1D, after the right end 165 is placed between the lateral walls 160, a left end 170 of the protective-film 130 is placed on the display screen 140, the lateral walls 160 ensuring proper registration of the protective-film 130. FIG. 1E depicts a perspective view of FIG. 1B.

As depicted, the sequences of steps demonstrates the manner for which to use the film-registration device 125. In the depicted, the lateral rails 150 engage the MED 120 along a major axis. Once engaged, the lateral walls 160 create a frame orthogonal to the display screen 130 at the engaged end of the MED 120. The lateral walls 160 receive the right end 165 of the protective film 130 containing the protective film 130 within the constructed frame. The left end 170 of the protective film 130 engages the display screen 140 while the right end 170 remains constrained by the frame of the lateral walls 160.

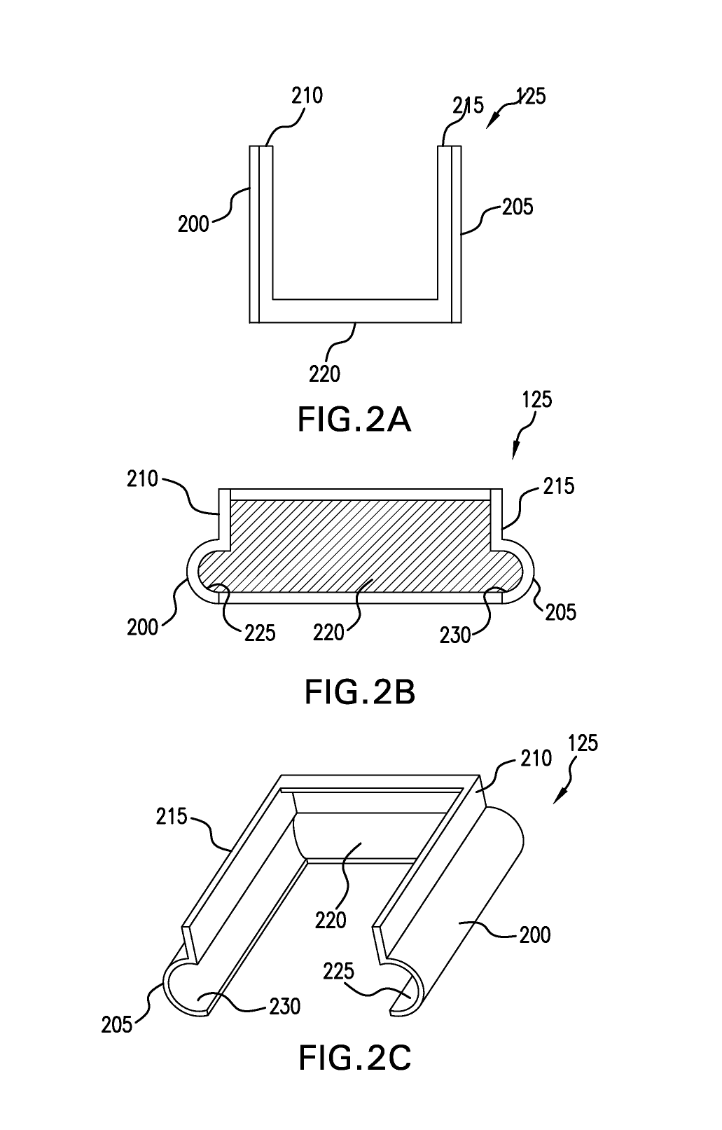

FIG. 2A depicts a top view of an exemplary film-registration device. As depicted, the film-registration device 125 includes a pair of opposing and substantially parallel lateral rails 200, 205. The lateral rails 200, 205 include respective lateral walls 210, 215. A longitudinal member 220 attaches to the opposing sides of the lateral rails 200, 205 and the lateral walls 210, 215. In some embodiments, the longitudinal member may restrict longitudinal movement of the MED with respect to the film-registration device.

FIG. 2B depicts a rear view of an exemplary film-registration device. As depicted, the lateral rails 200, 205 form opposing channels 225, 230 in a lateral plane, with the channels 225, 230 of each lateral rail 200, 205 facing each other. The lateral walls 210, 215 project substantially perpendicular to the lateral plane from the lateral rails 200, 205. In some embodiments, each lateral wall 210, 215 may include a planar surface, the planar surfaces facing each other. For example, the planar surface may substantially help to register the protective film 130 to the MED 120.

In some embodiments, the film-registration device 125 may be a unitary construct. The unitary construct may be constructed from rigid or semi-rigid materials. In some embodiments, both a rigid and semi-rigid material may be used. For example, the lateral walls 200, 205 may be constructed of a rigid material while the lateral walls 210, 215 are constructed from a semi-rigid material.

In some embodiments, the longitudinal member 220 functions as an engagement stop when engaging the lateral sides 135 of the MED to the lateral rails 200, 205. For example, first, the lateral sides 135 align to the lateral rails 200, 205. Second, the MED 120 slideably engages the lateral rails 200, 205 until the inserted end of the MED 120 abuts the longitudinal member 220. In some embodiments, the longitudinal member 220 may restrict longitudinal movement of the MED 120 with respect to the film-registration device 125.

FIG. 2C depicts a perspective view of an exemplary film-registration device. In the depicted embodiment, the channels 225, 230 formed by the lateral rails 200, 205 are concave to receive opposing lateral convex sides of a corresponding MED (e.g., iPhone® 6). In some embodiments, the channels may be rectangular in shape to accommodate a MED with opposing lateral rectangular sides (e.g., iPhone® 5).

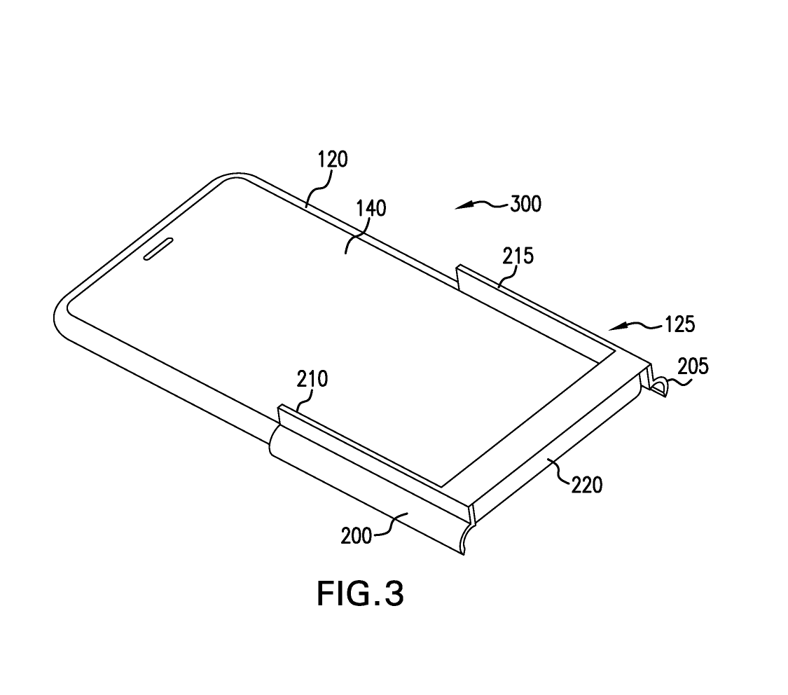

FIG. 3 depicts a perspective view of an exemplary film-registration device engaged with a mobile electronic device. The MED 120 slideably engages the lateral rails 200, 205 along the major axis 305 of the MED 120. The MED 120 abuts the longitudinal member 220 to achieve an engagement position 300. Once engaged 300, the lateral walls 210, 215 and the longitudinal member 220 create a frame around the display screen 140 of the MED 120. The protective-film 130 is constrained by the lateral walls 210, 215 to a predetermined position. The predetermined position may be the target area for locating the protective-film 130 on the display screen 140.

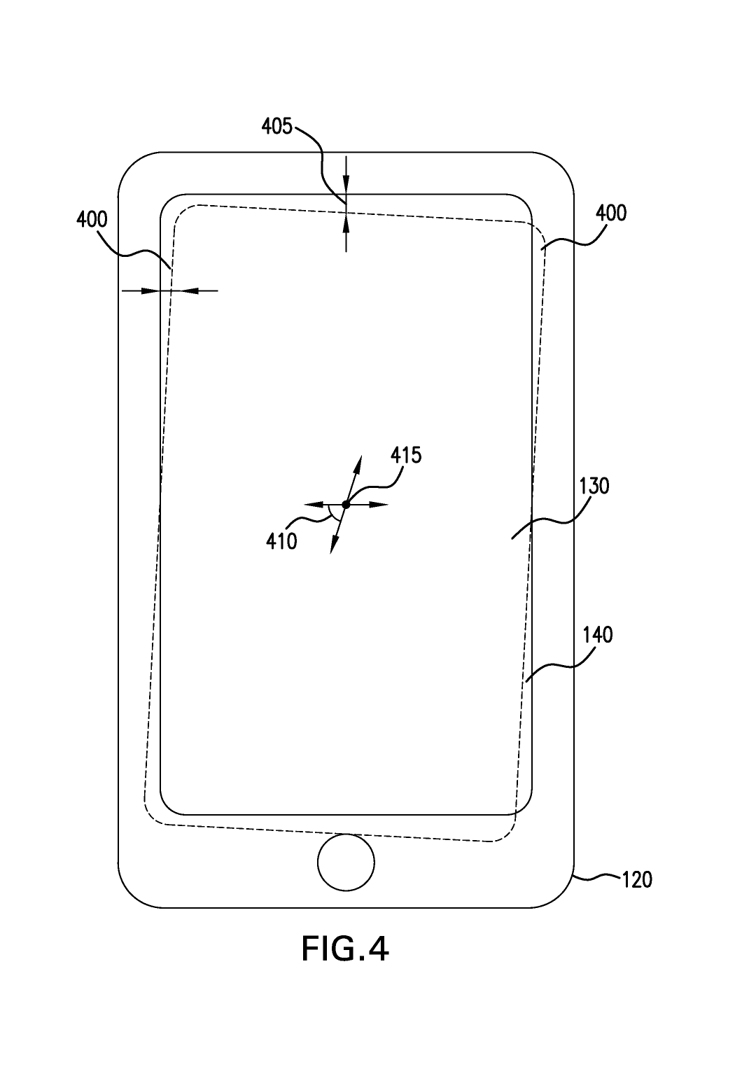

FIG. 4 depicts top view of an exemplary protective-film not properly registered to a mobile electronic device. As depicted, a protective-film 130 is improperly registered to the display screen 140 of the MED 120. The improper film registration exhibits both an offset of the target region 140 along the major axis 420 and the minor axis 425. As depicted, the lateral offset 400 leaves a portion of the display screen 140 along the major axis exposed and unprotected.

In the depicted, the improper registration creates a vertical offset 405 between the protective-film 130 and the display screen 140. The vertical offset 405 further leaves a portion of the display screen 140 along the minor axis 425 exposed and unprotected. Further, in the depicted, the improper film registration creates an angular offset 410 about a medial point 415 of the MED 120. The angular offset 415 rotates the protective-film 130 on top of the display screen 140. As depicted, the lateral offset 400 along with the angular offset 410 leaves a portion of each side of the display screen 140 both exposed and unprotected.

In some embodiments, a properly registered protective-film 130 may prevent deterioration of seal integrity between the protective-film 130 and the display screen 140 extending the useful service life of the protective-film 130. Deterioration of the seal integrity may introduce unwanted contaminants between the protective-film 130 and the display screen 140. For example, the introduction of dust between the protective-film 130 and the display screen 140 may increase the likelihood of the protective-film 130 falling off leaving the display screen 140 unprotected.

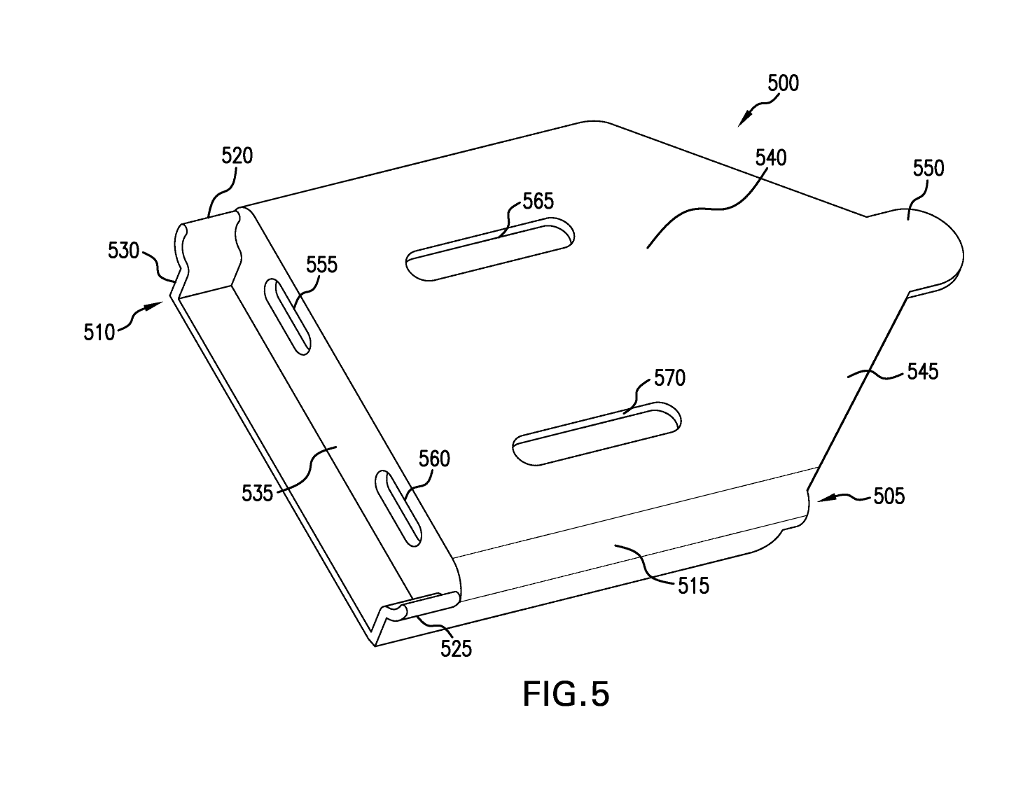

FIG. 5 depicts a perspective view of an exemplary film-registration device with a base member. As depicted, a film-registration device 500 includes a MED engagement portion 505 and a film-registration portion 510. The MED engagement portion 505 includes a pair of opposing lateral rails 515, 520. The lateral rails 515, 520 form opposing channels in a lateral plane, with the channels of each lateral rail 515, 520 facing each other. The film-registration portion 510 includes a pair of lateral walls 525, 530 extending from the lateral rails 515, 520. As depicted, a longitudinal member 535 connects substantially perpendicular to the lateral rails 515, 520 and the lateral walls 525, 530.

In the depicted embodiment, the lateral rails 515, 520 and the longitudinal member 535 attach to a base member 540. The base member 540 includes a convergent portion 545 extending from the lateral rails 515, 520. A U-shaped portion 550 extends from the convergent portion 545. In some embodiments, the base member 540 may restrict vertical movement of the MED 120 with respect to the film-registration device. In some embodiments, the U-shaped portion 550 may be used to facilitate coupling and uncoupling the MED 120 from the film-registration device 500, for example, with a consumer's fingers. In some embodiments, when the MED 120 engages the film-registration device 500, the base member 540 may restrict vertical movement of the MED 120 with respect to the film-registration device 500.

In some embodiments, the film-registration device 500 may align a display screen end of the film registration surfaces within 0 mm to 1 mm of the display screen 140. For example, a distance of 1 mm between the film registration surface and the display screen 140 may minimize the probability of the protective-film 130 sliding underneath the lateral walls 525, 530.

In the depicted embodiment, the longitudinal member 535 of the MED engagement portion 505 includes two apertures 555, 560. In some embodiments, the apertures 555, 560 may be used to access speakers and/or a microphone of the MED 120 while the MED 120 is engaged as shown, for example, in FIG. 3.

In the depicted embodiment, the base member 540 includes two parallel apertures 565, 570. In some embodiments, for example, when the MED 120 is engaged to the film-registration device 500, the parallel apertures 565, 570 may help to equalize ambient pressure by the engagement or disengagement of the MED 120 and the film-registration device 500. In some embodiments, the apertures 565, 570 may be diagonal.

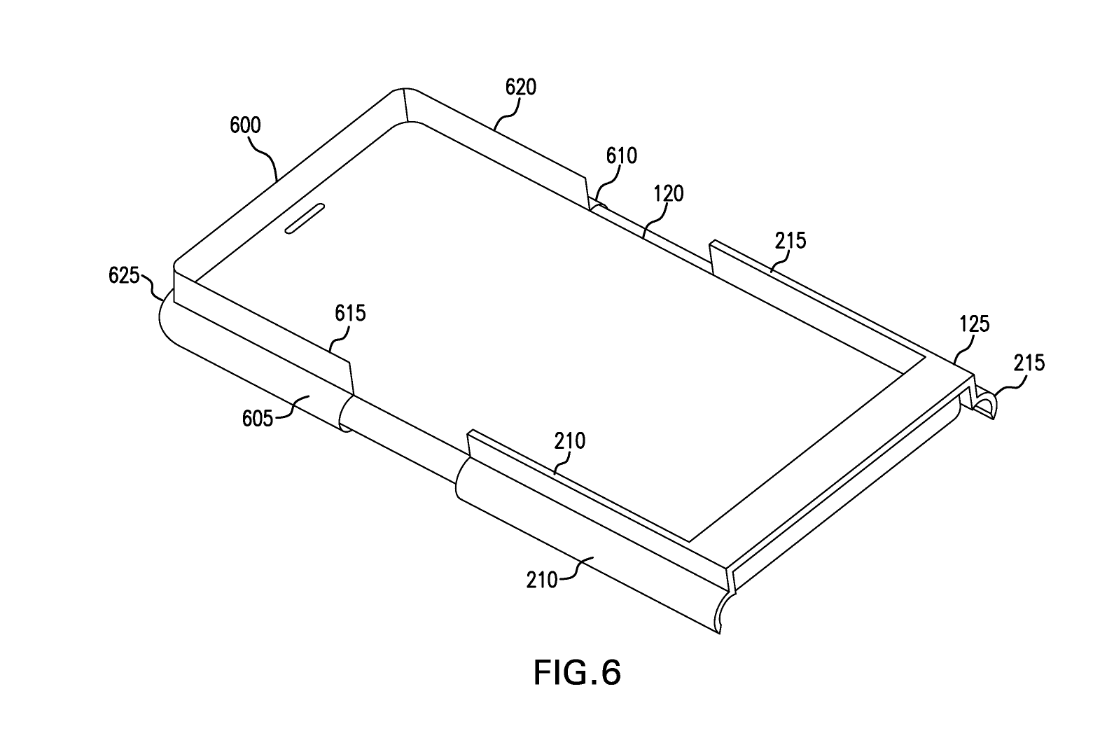

FIG. 6 depicts a perspective view of an exemplary pair of film-registration devices, each engaged to opposing sides of the mobile electronic device. As depicted, a film-registration device 600 includes lateral rails 605, 610. Each of the lateral rails 605, 610 includes respective lateral walls 615, 620. The film-registration device 600 includes a longitudinal member 625. The film-registration device 600 engages the MED 120 at an opposite end along the major axis to the film-registration device 125. The film-registration devices 125 600 mirror each other at opposite ends along the major axis 305 of the MED 120. When both film-registration devices 125, 600 are engaged, the lateral walls 210, 215, 615, 620 and longitudinal members 220, 625 create a frame around the display screen 140 at opposite ends of the MED 120. In some embodiments, the frame around the display screen 140 screen may substantially prevent the protective-film 130 from being positioned improperly, either laterally or vertically during application.

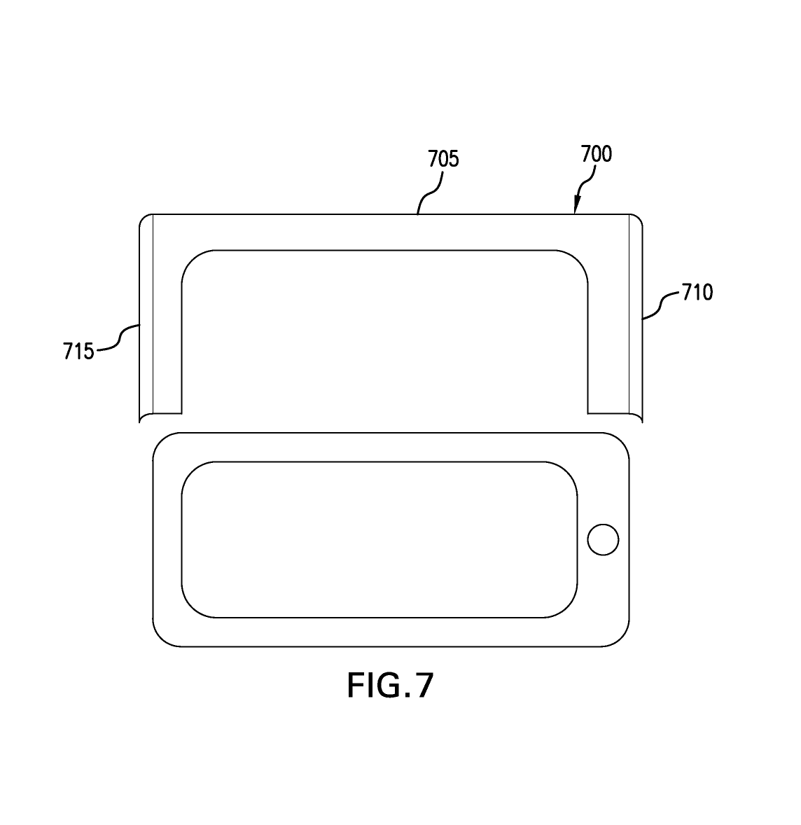

FIG. 7 depicts a top view of an exemplary film-registration device with lateral rails to engage a mobile electronic device along the minor axis of the mobile electronic device. As depicted, the film-registration device 700 includes a longitudinal member 705 oriented parallel to the major axis 420 of the MED 120. The lateral rails 710, 715 correspond to the minor axis 425 of the MED 120. In some embodiments, the MED 120 may slideably engage the film-registration device 700 along the minor axis. In some embodiments, the lateral rails 710, 715 may snapfit to the MED 120.

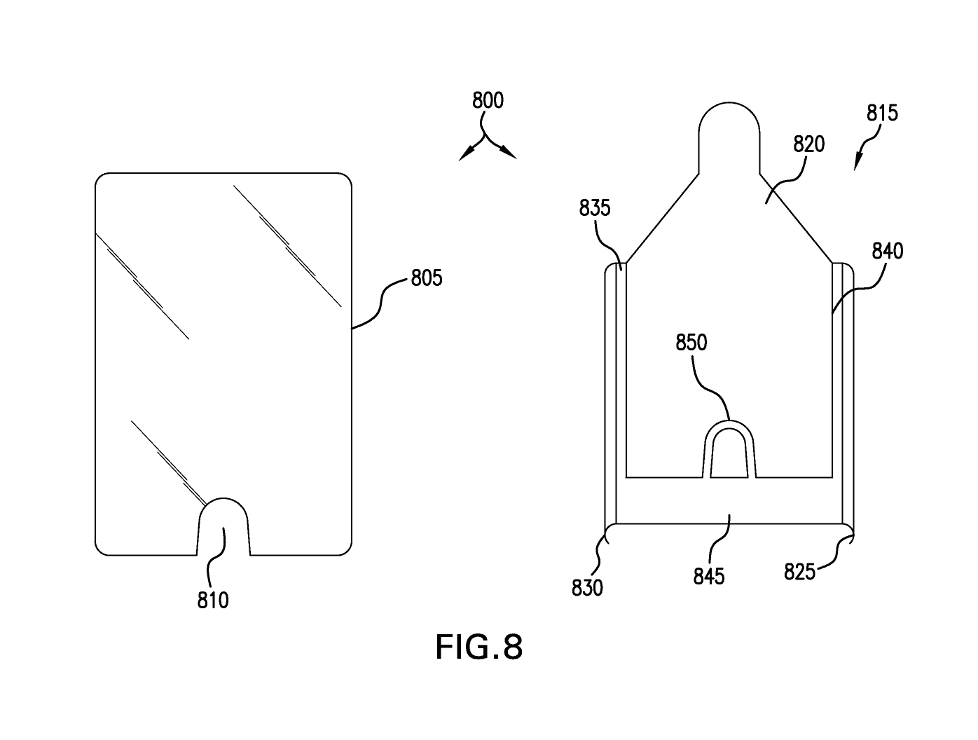

FIG. 8 depicts a perspective view of an exemplary kit including a protective-film with a U-shaped cutout and a film-registration device with a U-shaped protrusion. As depicted, a kit 800 includes a protective-film 805. The protective-film 805 includes a U-shaped cutout 810. The kit 800 further includes a film-registration device 815. The film-registration device 815 including a base member 820. The base member 820 attaches to the lateral rails 825, 830. In the depicted embodiment, two lateral walls 835, 840 extend from the lateral rails 825, 830. A longitudinal member 845 attaches to the lateral rails 825, 830 and the lateral walls 835, 840. As depicted, a U-shaped protrusion 850 extends parallel to the major axis from the longitudinal member 845.

In some embodiments, the U-shaped protrusion 850 aligns with the U-shaped cutout 810. In combination, the U-shaped protrusion 850 and the U-shaped cutout 810 may prevent angular offset between the protective-film 805 and the display screen 140 of the MED 120 during registration.

In some embodiments, the kit 800 may include a protective-film with a rectangular-shaped cutout and a film-registration device with a rectangular-shaped protrusion. The kit 800 may further contain, for example, a set of instruction (not shown) for use of the film-registration device. In some embodiments, the kit 800 may contain a cleaning cloth and/or cleaning solution (not shown) to promote cleaning the target surface area (not shown).

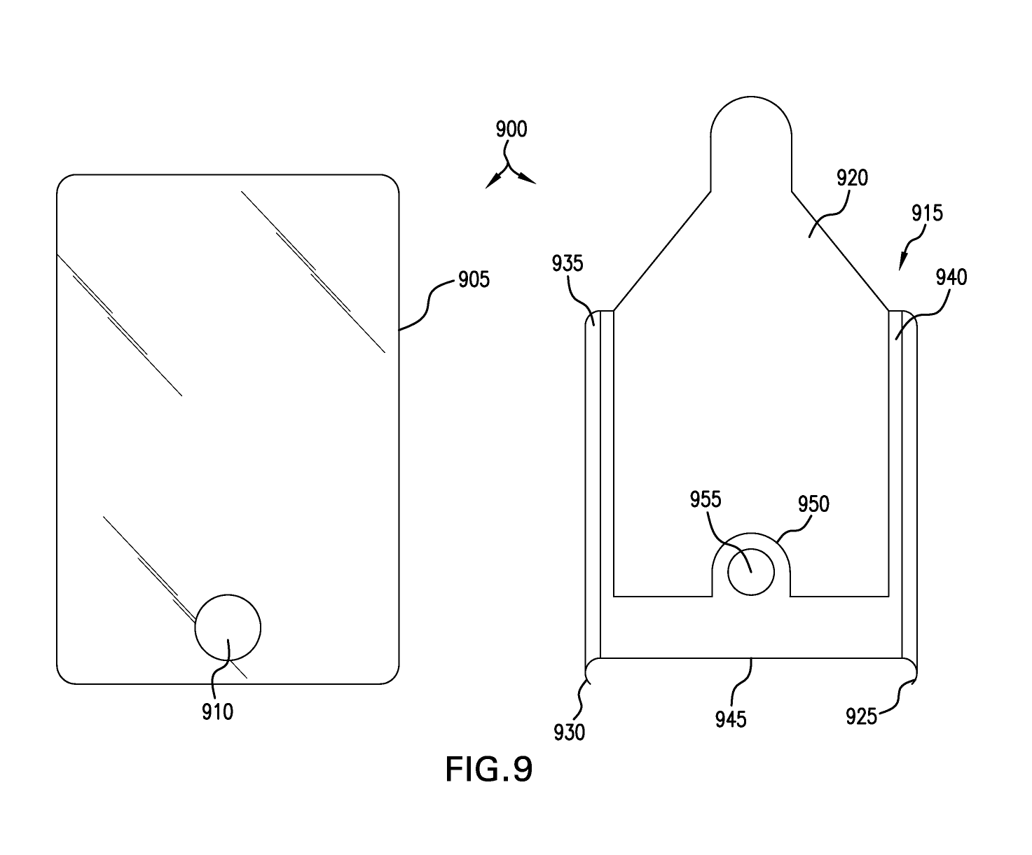

FIG. 9 depicts a top view of an exemplary kit including a protective-film with a circle-shaped cutout and a film-registration device with a circle-shaped aperture. As depicted, a kit 900 includes a protective-film 905. The protective-film 905 includes a circle-shaped cutout 910. The kit 900 further includes a film-registration device 915. The film-registration device 915 including a base member 920. The base member 920 attaches to the lateral rails 925, 930. In the depicted embodiment, two lateral walls 935, 940 extend from the lateral rails 925, 930. A longitudinal member 945 attaches to the lateral rails 925, 930 and the lateral walls 935, 940. As depicted, a U-shaped protrusion 950 with a circular aperture 955 extends parallel to the major axis from the longitudinal member 945.

In some embodiments, the circular aperture 955 may substantially inhibit unintended lateral slippage of the protective-film 905 during registration to a MED. For example, when a MED is fully engaged to the film-registration device 915, the circular aperture 955 may include a spring-biased retractable circular protrusion to engage the circular cutout 910. The engagement of the retractable circular protrusion to the circular cutout may secure the protective-film 905 along the major axis of the MED. In some embodiments, the aperture 955 may be rectangular.

In some embodiments, the kit 900 may include a protective-film with a cylindrical-shaped cutout and a film-registration device with a corresponding cylindrical-shaped aperture. The kit 900 may further include a packaging (not shown) that may can contain a protective film 905 and a film-registration device 915.

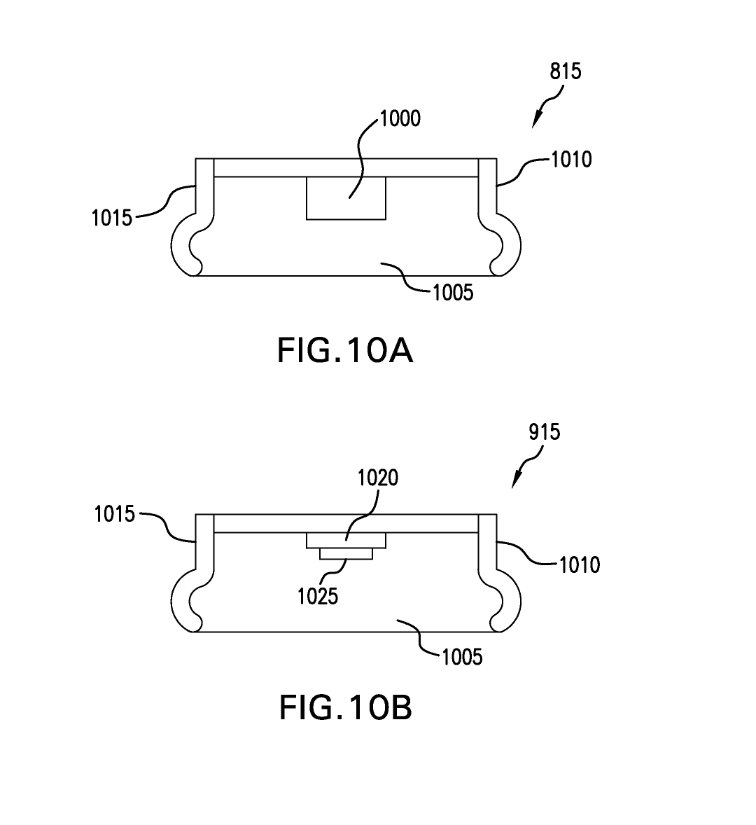

FIG. 10A depicts a front view of an exemplary film-registration device with a U-shaped protrusion. The film-registration device 815 includes a U-shaped protrusion 1000 extending from the longitudinal member 1005 substantially parallel to the lateral walls 1010, 1015. In some embodiments, the U-shaped protrusion 1000 may be a solid construct.

FIG. 10B depicts a front view of an exemplary film-registration device with a circle-shaped aperture. The film-registration device 915 includes a U-shaped protrusion 1020 with a circular aperture extends from the longitudinal member 1005 substantially parallel to the lateral walls 1010, 1015. As depicted, a retractable circular protrusion 1025 extends from the circular aperture of the U-shaped protrusion 1020. In some embodiments, the retractable protrusion may be rectangular.

Although various embodiments have been described with reference to the Figures, other embodiments are possible. For example, in some embodiments and with reference to FIG. 2, the longitudinal member 220 may include to two portions slideably coupled to adjust the distance between the lateral rails 200, 205. For example, a film-registration device may be adjusted to accommodate various dimensions of different MEDs. In some embodiments, the lateral rails 200, 205 may be interchangeable. For example, the lateral rails 200, 205 with concave channels 225, 230 may be interchanged with lateral rails with rectangular shaped channels. This may be advantageous, for example, it may substantially eliminate the need for multiple film-registration devices for different dimensioned MEDs. In some embodiments, the opposing lateral rails 200, 205 may be asymmetrical. For example, a MED may have opposing lateral sides where one side is rectangular and the other side is convex.

In some embodiments, the concave channels 225, 230 may contain only the portion connecting to the lateral walls 210, 215 forming arcs. The arcs may be used to engage the MED 125 by placing the film-registration device 125 on the MED 120 on the side of the display screen 140. In some embodiments the lateral rails 200, 205 may be constructed of a semi-rigid material to snappedly engage the MED 120.

In some embodiments, the film-registration device may include a single lateral alignment member and longitudinal member 220. The lateral alignment member and the longitudinal member may connect substantially perpendicular to each other creating an L-shaped frame. The lateral alignment member may include a single lateral rail 200 and single lateral wall 210. For example, the lateral alignment member and the longitudinal member 220 may engage the MED 120 at a corner where a lateral side 135 of the MED 120 connects substantially perpendicular to a longitudinal side of the MED 120. The protective film 130 may register to the target planar surface 140 by aligning a corner of the protective-film 130 to the L-shaped frame.

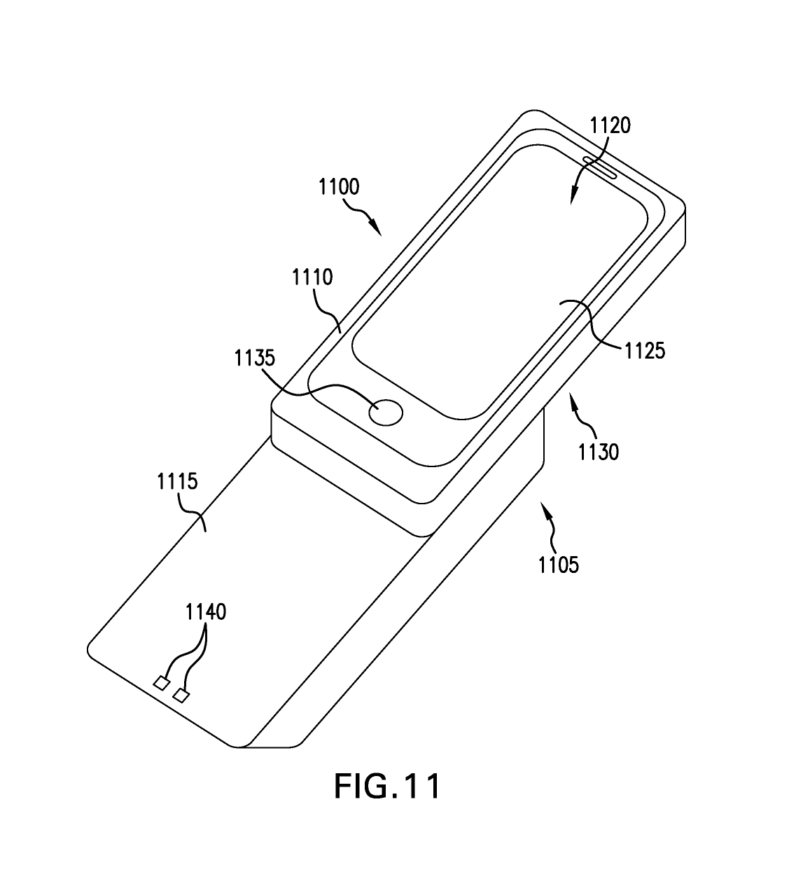

FIG. 11 depicts a perspective view of an exemplary protection system for mobile electronic device. In the FIG. 11 depiction, mobile electronics device (MED) 1100 is shown with an exemplary MED accessory system 1105. The depicted MED accessory system 1105 includes a protective cover 1110 and a slidably removable battery pack 1115. The protective cover 1110 provides complete peripheral protection of the MED 1100 against contact with a flat surface. The protective cover 1110 slideably engages a batter pack 1115 that substantially covers a back side 1130 of the protective cover 1110 when completely engaged. The battery pack 1115 may have electrical contacts 1140 that align with and contact corresponding electrical contacts on the back side 1130 of the protective cover 1110. The battery pack 1110 may provide and/or supplement operating power of the MED 1100 via the electrical contacts 1140. The battery pack 1115 may be removed when discharged and replaced with a fully charged battery pack, without compromising the peripheral protection of the MED 1100. In this way, the protective cover 1110 may advantageously and continuously provide peripheral protection of the enclosed MED 1100 while facilitating replacement of a battery pack 1110.

In some embodiments, a protective cover 1105 may substantially cover all side of the MED 1100 except perhaps a front side 1120, which may include a display screen 1125. The protective cover 1110 may have apertures or windows to facilitate a user's viewing of the display screen 1125. Windows or apertures on the front side 1120 or on a back side 1130 may facilitate a camera device to image scenes without obstruction by the protective cover 1110. In some embodiments, apertures in the protective cover 1110 may facilitate access to user controls, such as, for example, buttons 1135 and/or switches. The protective cover 1110 may facilitate the unimpeded transmission of audio signals to and from the MED 1100. In some embodiments, the protective cover 1110 may electrical couple to a communications port of an MED 1100. In some instances, the communications port may be buffered and/or replicated. For example, an illustrative protective cover 1110 may have a USB connector configured to be electrically coupled to a USB port of an MED 1100. The signals from the USB port may then be communicated to one or more interface connections on the protective cover 1110. The user may then electrically connect a power charger and/or a USD device to one or more of the provided interface connections.

In the depicted embodiment, the battery pack 1115 is slideably coupled to the protective cover 1110. The battery pack 1115 may have rail features that corresponds to complementary rail features attached to a back or sidewalls of the protective cover 1110. In some embodiments, one of the battery pack 1115 and the protective cover 1110 may have longitudinal recesses to accept one or more projecting features from the other of the battery pack 1115 and the protective cover 1110. In some embodiments, the battery pack 1115 and the protective cover 1110 or MED 1100 may have complementary electrical interfaces that engage with each other when the battery pack 1115 is coupled to the protective cover 1110. In some embodiments, the battery pack 1115 may have an indicator that provides a visual signal indicative of a battery status. For example, in some embodiments, a green light-emitting diode (LED) may be illuminated when the battery is fully charged. A red LED may be illuminated, in some embodiments, when the battery is nearly depletion of charge, for example. In an exemplary embodiment, a series of LEDs may indicate the relative charge of the battery.

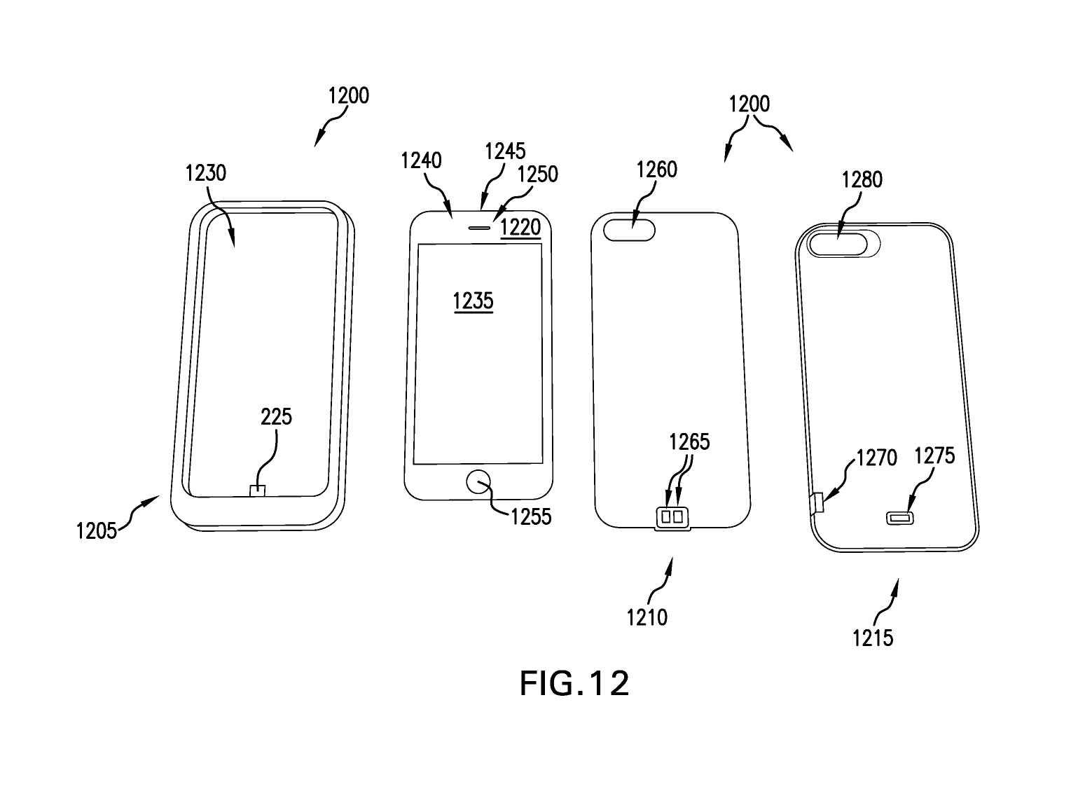

FIG. 12 depicts an exemplary peripheral protection system separated from a mobile electronic device. In the FIG. 12 depiction, and exemplary peripheral protection system 1200 includes a face piece 1205, a back piece 1210 and a coupleable battery pack 1215. Also depicted in FIG. 12 is an MED 1220 for which the exemplary peripheral protection system 1200 is designed. The depicted peripheral protection system 1200 is separated from the MED 1200. The face piece 1205 includes an electrical interface 1225 configured to connect to a corresponding electrical interface of the MED 1220. The face piece 1205 has an aperture 1230 through which a display screen 1235 of the MED 1220 may be seen, when the face piece 1205 is connected to the MED 1220. The aperture 1230 also provides unobstructed access to a camera 1240, a microphone 1245, and a speaker 1250 located on a front side of the MED 1220. A control button 1255 may be accessed through the aperture 1230 in the face piece 1205.

In some embodiments, the back piece may have one or more apertures 1260, 1265. In the FIG. 12 depicted embodiment, a camera aperture 1260 may facilitate light access to and from a camera and/or a light emitting device. Power contact apertures 1265 may facilitate electrical contact between the battery pack 1215 and the face piece 1205 and/or the MED 1220. In some embodiments, the face piece may present contacts that are configured to engage corresponding contacts on the battery pack 1215 via contact apertures 1265 in a back piece. In some embodiments, the back piece 1210 may electrically couple to the face piece 1205 and/or the MED 1220 via an electrical interface of the back piece 1210. The back piece 1210, may then have contacts configured to engage a battery pack 1220. In the depicted embodiment, the battery pack 1215 has a charging port 1270 and an electrical interface port 1275. In an exemplary embodiment, the electrical interface port may be configured to interface with a standard interface port. For example, electrical interface port 1275 may be configured to couple to an external device using a micro USB connector. In some embodiments, a charging port 1270 may be configured to interface with a standard charging connector. In an exemplary embodiment, the charging port 1270 may be configured to interface with a custom charging connector.

In some embodiments, the battery pack 1215 may be recharged while coupled to the back piece 1210 and/or the MED 1220. In some embodiments, the battery pack 1215 may be recharged while decoupled from the back piece 1210 and/or the MED 1220. In this way, a battery pack 1215 may provide operating power to an MED 1220 to which it is attached, while a second battery pack 1215 may be recharged while detached from the MED 1220. Such a second battery pack 1215 may be then made ready for use when the first battery pack 1215 is fully discharged. In the depicted embodiment, the battery pack 1215 is designed to be unobstructive of light to and from a camera and/or a light-emitting device. In the depicted embodiment, an aperture 1280 provides visual access both to and from an MED 1220.

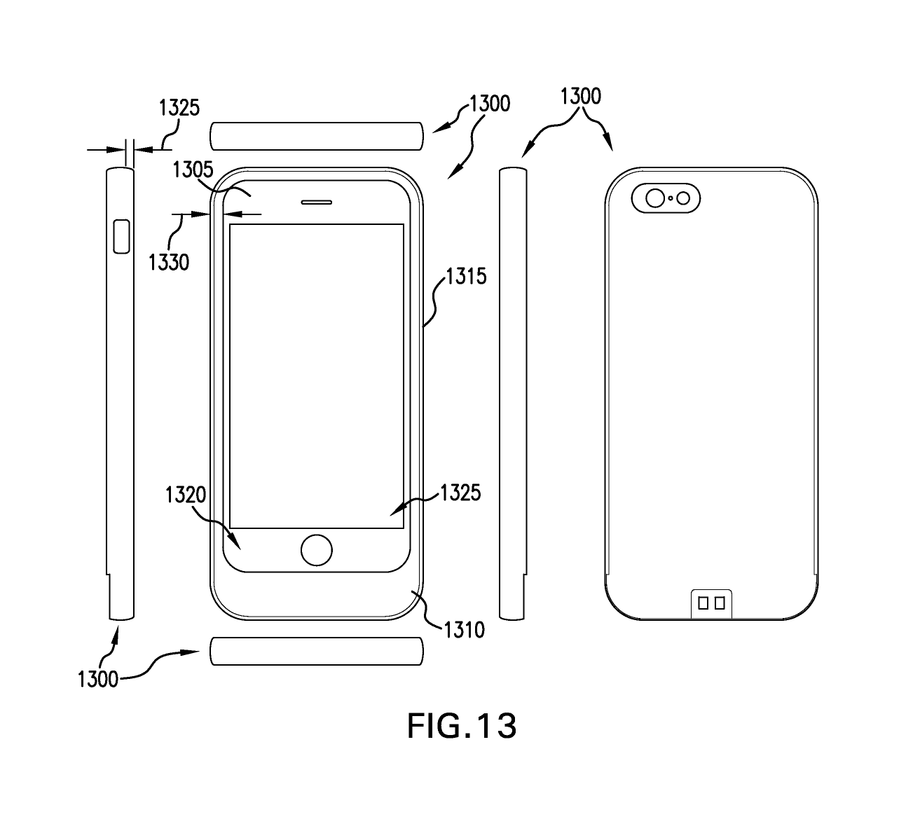

FIG. 13 depicts various plan and side-elevation views of an exemplary protective cover of a mobile electronic device with no supplementary batter pack attached. In the FIG. 13 depiction, a protected MED 1300 includes an MED 1305 and a protective cover 1310. The protective cover 1305 provides full peripheral protection of the MED against contact with flat or concave surfaces. Such full peripheral protection may result from a protective lip 1315 projecting above a front surface 1320 of the MED 1305. The protective lip 1315 may engage a flat surface thereby preventing engagement of the front surface 1320 of the MED 1305 with the flat surface. Because of the protective lip 1315, only concave figures, such as a user's finger, may engage the front surface 1320 of the MED 1305. Concave objects must project through a display aperture 1325 of the protective cover 1310 to engage the front surface 1320 of the MED 1305.

In some embodiments, the front surface 1320 of the MED 1305 is substantially flat. In some embodiments, only concave features may be present on a front surface of a display screen. For MEDs having substantially flat and/or only concave features on the front surface 1320, the protective lips 1315 need only project a modest distance 1325 above the front surface 1320 to provide protection against contact with flat or concave surfaces. A distance of protective lip projection 1325 may correspond to provide a predetermined level of protection. For example, a protective lip projection 1325 may be designed to provide fall protection for an MED 1305 of two meters. In some embodiments, the protective lips 1315 may have a lip width 1330 configured to provide a predetermined level of protection against contact. For example, a protective lip width may be designed to provide fall protection for an MED 1305 of 5 meters.

In an exemplary embodiment, a protective cover 1305 may be designed to provide a predetermined level of protection for an MED 1305 having one or more projecting features (e.g., a button) from a front surface 1320. The protective lips 1315 may have a projecting distance that is greater than the projecting distance of the one or more projecting features from the front surface 1320.

In some embodiments, the material of the protective lip 1315 may be designed to distribute a force over a span of time and/or space. For example, the material of the protective lip 1315 may be such that when a specific location of the protective lip 1315 engages an object, the resulting force to the protective lip 1315 is distributed along a length of the protective lip 1315. In some embodiments, the protective lip 1315 may include a stiffening member. The stiffening member may facilitate distribution of a force along a longitudinal dimension of the protective lip 1315. The maximum force delivered to any specific location of the MED 1305 may be reduced using a stiffening agent, because the force may be distributed along a greater surface area of the MED, for example.

The force that results from an object contacting the protective lip 1315 may also be distributed in time as the protective lip undergoes compression. For example, when the protective lip 1315 first contacts an object, a force is imparted from the object to the protective lip 1315. This force is then communicated to the MED 1305 via the protective lip. As the object continues to contact the protective lip 1315, the force imparted to the protective lip 1315 may increase. The protective lip may absorb some of the imparted force by compression of the protective lip. The force may communicated the remaining force to the MED 1305. At a later time, when the object is no longer in contact with the protective lip 1315, the protective lip 1315 may uncompress. This uncompression may return the protective lip to its natural geometry, while also imparting a force to the MED 1305. By distributing the force in space and/or time, the maximum force imparted to the MED 1305 may be minimized, thereby protecting the MED 1305.

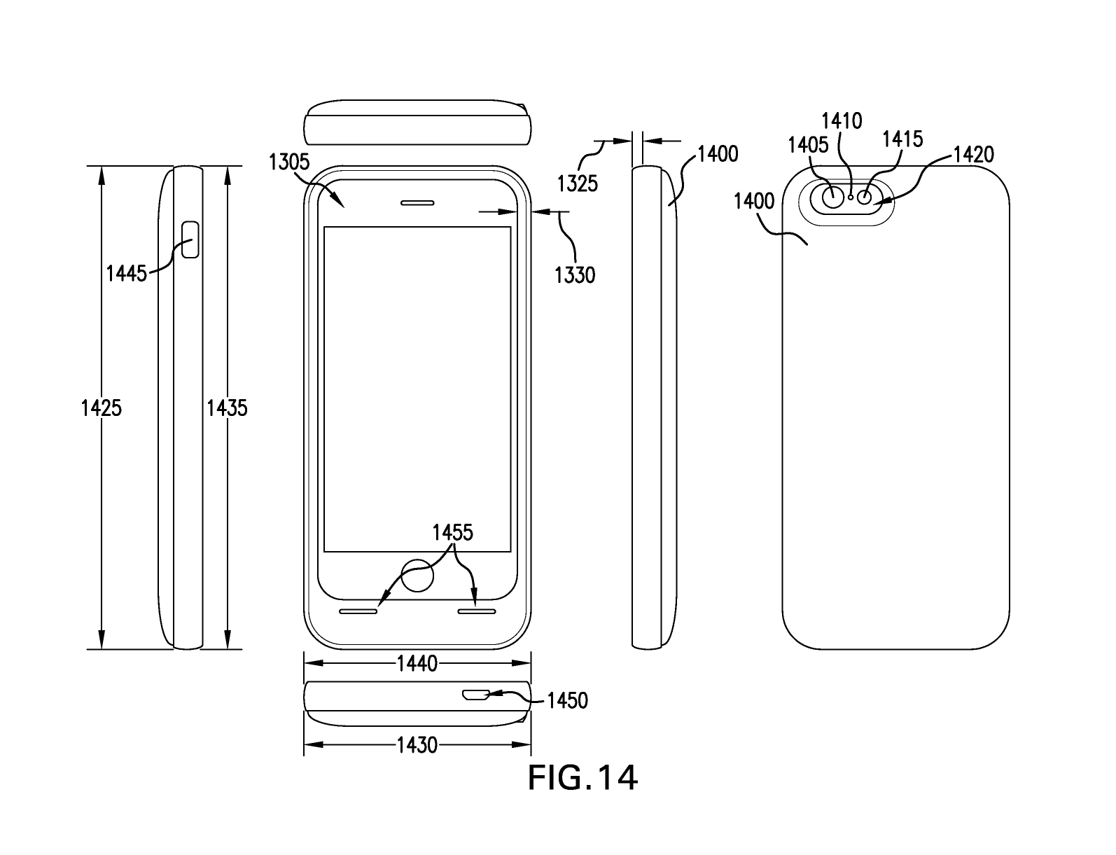

FIG. 14 depicts various plan and side-elevation views of an exemplary protective cover of a mobile electronic device with a supplementary batter pack attached. The FIG. 14 depiction shows the exemplary protective cover 1305 shown in FIG. 13, but with a battery pack 1400 attached thereto. In FIG. 14, a camera 1405, a microphone 1410 and a light emitting device 1415 of the MED 1305 can be seen through an aperture 1420 in the battery pack 1400. The depicted battery pack 1400 has a width 1425 and a length 1430 that is substantially equal to a length 1435 and a width 1440 of the protective cover 1315. The exemplary protective cover 1315 provides mechanical communication 1445 with an operator button on a lateral side of the MED 1305. The depicted protective cover 1315 also provides an electronic interface port 1450 on a bottom side of the protective cover 1315. In some embodiments additional audio speakers 1455 may provide enhanced audio provided by the MED 1305.

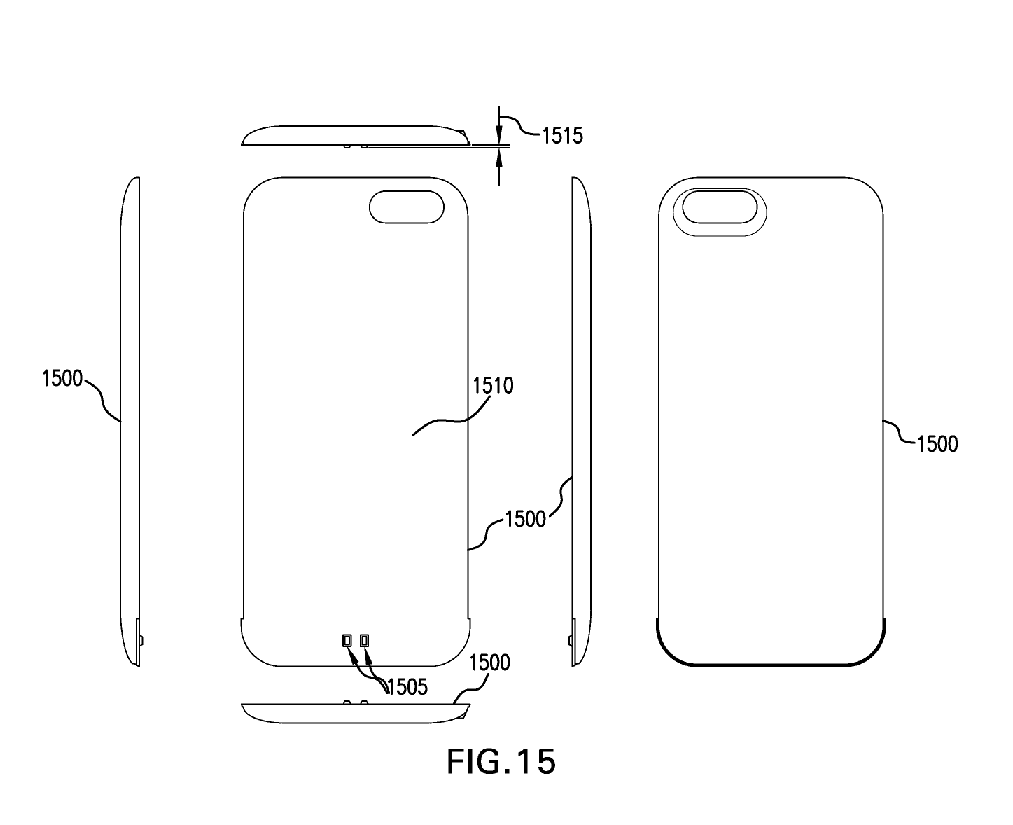

FIG. 15 depicts various plan and side-elevation views of an exemplary supplementary batter pack configured for attachment to a protection system for a mobile electronic device. In the FIG. 15 depiction, a battery pack 1500 has a pair of electrical contacts 1505 for providing electrical connectability between the battery pack 1500 and an MED 1305. In the depicted embodiment, the electrical contacts 1505 may project above an engagement surface 1510 by a distance 1515. The distance 1515 may be greater than or equal to a distance between the engagement surface 1510 and contacts on the protective cover 1310 and/or contacts on the MED 1305, so as to facilitate electrical contact between the electrical contacts 1505 on the battery pack 1500 and corresponding electrical contacts on the protective cover 1310 and/or the MED 1305.

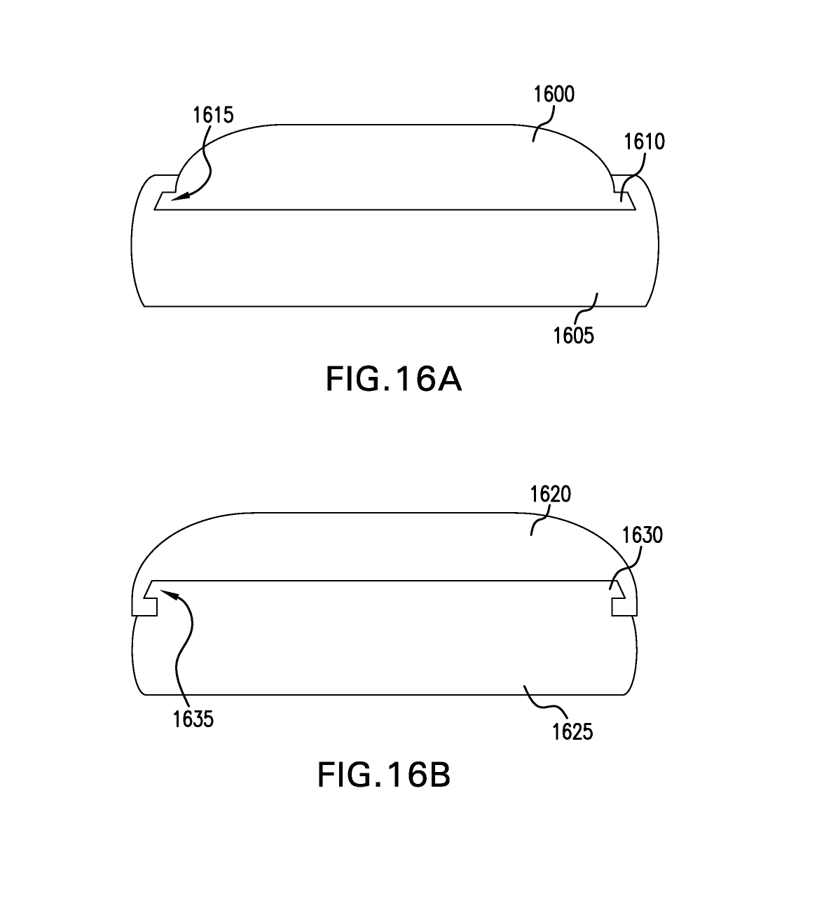

FIGS. 16A-16B depict side-elevation views of exemplary slideably connected battery packs. In the FIG. 16A depiction, a battery pack 1600 is slideably coupled with a protective cover 1605. The battery pack 1600 has lateral projections 1610 that slidably engage lateral recesses 1615 in the protective cover 1605. In the FIG. 16B depiction, a battery pack 1620 is slideably coupled with a protective cover 1625. The protective cover 1625 has lateral projections 1630 that slidably engage lateral recesses 1635 in the battery pack 1620.

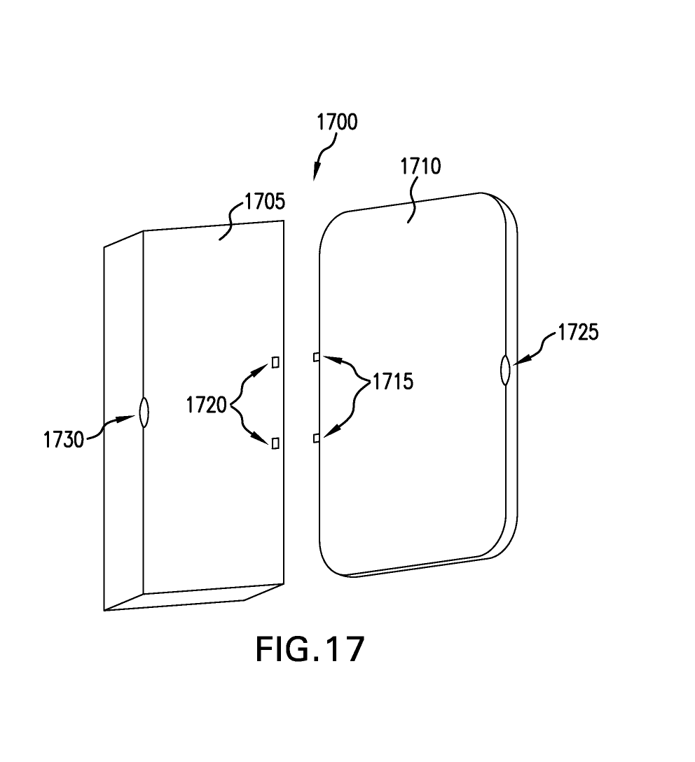

FIG. 17 depicts a perspective view of an exemplary hingeably connected supplementary battery pack for a protected mobile electronics device. In the FIG. 17 depiction, an exemplary MED protection system 1700 includes a peripherally protected MED 1705 and a supplemental detachable battery platform 1710. The supplemental detachable battery platform 1710 has hinge members 1715 that releasably and hingably coupled with complementary hinge members 1720 of the peripherally protected MED 1705. The supplemental detachable battery platform 1710 includes a latching member 1725 configured to engage a complementary latching member 1730 of the peripherally protected MED 1705.

In various embodiments, various coupling members may be used to couple a supplemental battery platform to a peripherally protected MED. For example, a supplemental battery platform may snap to a peripherally protected MED. A supplemental battery platform may rotatably couple to a peripherally protected MED. In some embodiments, the supplemental battery platform may be secured to the peripherally protected MED via a detent. In an exemplary embodiment the supplemental battery platform may be secured to the peripherally protected MED via a latching member (e.g. a spring-loaded connector).

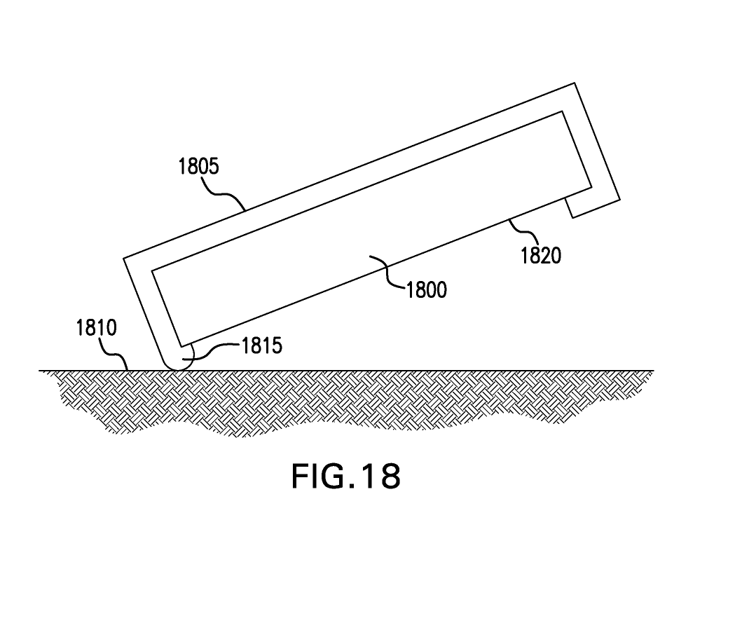

FIG. 18 depicts a side elevation view of a cross-sectioned MED 1800 in a contact event with a flat surface 1810. The peripherally protected MED 1800 is coupled to a peripheral cover 1815. The peripheral cover has projecting lips 1815 that project above a front surface 1820 of the MED 1800. The projecting lips 1815 engage the flat surface 1810.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

1. An apparatus for registering a protective film to a target surface of a mobile electronic device (MED), the apparatus comprising:
a unitary construct configured to engage and align to a MED, the unitary construct including:
a lateral alignment member having a MED engagement surface and a substantially-planar film-registration surface, the MED engagement surface of the lateral alignment member configured to engage a surface of a lateral end of the MED and to restrict movement of the MED with respect to the unitary construct in at least one lateral direction;
a longitudinal alignment member having a MED engagement surface and a film-registration surface, the MED engagement surface configured to engage a surface of a longitudinal end of the MED and to restrict movement of the MED with respect to the unitary construct in at least one longitudinal direction; and
a vertical alignment member having a MED engagement surface configured to engage a surface of a vertical end of the MED and to restrict movement of the MED with respect to the unitary construct in at least one vertical direction;
wherein, when the MED is engaged with the unitary construct laterally, longitudinally, and vertically, the lateral and longitudinal substantially-planar film-registration surfaces project above the display screen and are coplanar with planes having display screen intersections that are substantially congruent with peripheral edge portions of a protective film, when the protective film is aligned with and affixed to the display screen.

2. The apparatus of claim 1, wherein when the unitary construct is engaged laterally, longitudinally and vertically with the MED, a display screen end of the film registration surfaces are within 1 mm of the display screen.

3. The apparatus of claim 1, wherein when the unitary construct is engaged laterally, longitudinally and vertically with the MED, a display screen end of the film registration surfaces are in contact with the display screen.

4. The apparatus of claim 1, comprising a second lateral alignment member having a MED engagement surface and a substantially-planar film-registration surface, the MED engagement surface of the lateral alignment member configured to engage a surface of a lateral end of the MED and to restrict movement of the MED with respect to the unitary construct in at least one lateral direction.

5. The apparatus of claim 4, wherein the engagement surface of each of the lateral alignment members is concave, with the concavity of each engagement surface facing each other.

6. The apparatus of claim 4, wherein the two opposing lateral alignment members have substantial mirror symmetry with respect to each other.

7. The apparatus of claim 1, wherein the unitary body construct is rigid or semi-rigid.

8. The apparatus of claim 1, further comprising a U-shaped projection extending from the longitudinal member, the U-shaped projection aligning to a corresponding MED button.

9. An apparatus for registering a protective film to a target surface of a mobile electronic device (MED), the apparatus comprising:
a unitary construct configured to engage and align to a MED, the unitary construct including:
a lateral alignment member having a MED engagement surface and a substantially-planar film-registration surface, the MED engagement surface of the lateral alignment member configured to engage a surface of a lateral end of the MED and to restrict movement of the MED with respect to the unitary construct in at least one lateral direction;
a longitudinal alignment member having a MED engagement surface and a film-registration surface, the MED engagement surface configured to engage a surface of a longitudinal end of the MED and to restrict movement of the MED with respect to the unitary construct in at least one longitudinal direction;
a vertical alignment member having a MED engagement surface configured to engage a surface of a vertical end of the MED and to restrict movement of the MED with respect to the unitary construct in at least one vertical direction; and
a protective film designed to the dimensions of the display of the MED,
wherein, when the MED is slideably engaged with the unitary construct, the lateral and longitudinal substantially-planar film-registration surfaces project above the display screen and are substantially orthogonal to the display screen, the substantially-planar film-registration surfaces each intersection substantially congruent with peripheral edge portion of a protective film, when the protective film is aligned with and affixed to the display screen.

10. The kit of claim 9, wherein when the unitary construct is engaged laterally, longitudinally and vertically with the MED, a display screen end of the film registration surfaces are in contact with the display screen.

11. The kit of claim 9, comprising a second lateral alignment member having a MED engagement surface and a substantially-planar film-registration surface, the MED engagement surface of the lateral alignment member configured to engage a surface of a lateral end of the MED and to restrict movement of the MED with respect to the unitary construct in at least one lateral direction.

12. The kit of claim 11, wherein the engagement surface of each of the lateral alignment members is concave, with the concavity of each engagement surface facing each other.

13. The kit of claim 9, further comprising a screen-safe cloth to prepare the display of the MED for registration of the protective film, wherein the screen-safe cloth comprises soft microfibers.

14. The kit of claim 9, wherein the unitary body construct is rigid or semi-rigid.

15. The kit of claim 9, further comprising a U-shaped projection extending from the longitudinal member, the U-shaped projection aligning to a corresponding MED button.

16. The kit of claim 15, wherein the protective film contains a U-shaped cutout, the U-shaped cutout corresponding to the U-shaped projection.

17. An apparatus for registering a protective film to a display screen of a mobile electronic device (MED), the apparatus comprising:
a unitary construct;
means for aligning the unitary construct with a MED; and
means for registering the protective film to the unitary construct, thereby registering the protective film to the MED when MED and the protective film are concurrently aligned with the unitary construct.

18. The apparatus of claim 17, wherein means for aligning the unitary construct with a MED includes an engagement portion, the engagement portion including a lateral engagement surface.

19. The apparatus of claim 17, wherein means for aligning the unitary construct with a MED includes an engagement portion, the engagement portion including a longitudinal engagement surface.

20. The apparatus of claim 17, wherein means for registering the protective film to the unitary construct includes means for simultaneously engaging a protective film on both a lateral side and a longitudinal side of the protective film.
